(19) United States
(12) Patent Application Publication
(10) Pub. No.: US 2012/0005075 A1
(43) Pub. Date: Jan. 5, 2012

(54) SYSTEMS AND METHODS FOR INCREASING COLLECTION AGREEMENT FULFILLMENT AND TRACEABILITY

(75) Inventors: Kurt Bulawa, Parker, CO (US); Michael Michelsen, Arvada, CO (US); Michele Demark, Highlands Ranch, CO (US); Dave Owen, Castle Rock, CO (US)

(73) Assignee: The Western Union Company, Englewood, CO (US)

(21) Appl. No.: 12/830,025

(22) Filed: Jul. 2, 2010

(51) Int. Cl. G06Q 40/00

(52) U.S. Cl. 705/39

(57) ABSTRACT

A system for receiving a payment for a financial obligation of a payer via a staged transaction, and for identifying an originator of the staged transaction. A collection system may be configured to, per the originator, associate the obligation with an identifier which may be unique to the obligation and indicative of the originator, to associate the transaction with the identifier, and to provide the identifier to the payer. A provider system may be configured to receive a first record related to the transaction from the collection system, to receive a second record related to the transaction which indicates a payment has been received, and to send a third record related to the transaction to the collection system which indicates a payment has been received. A provider subsystem may be configured to receive the identifier from the payer, and send the second record to the provider system.

### BACKGROUND OF THE INVENTION

This invention relates generally to staged financial transactions between parties. More specifically the invention relates to staged financial transactions for the collection of obligations owed between parties and tracing the person responsible for staging transactions.

When any party, particularly merchants and service providers, are owed money by another party, there can be delays in receiving payments on such obligations. Reminders from billers such as mailings and e-mails may have limited effect. Often though, interaction by a human-agent of the biller with the debtor may assist in motivating the debtor to follow through and fulfill the financial obligation.

Often, some human-agents, or possibly automated systems of the biller for reminding a debtor, have differing levels of effectiveness. Often it is impossible to determine which human-agent or automated system prompted fulfillment by the debtor. Additionally payment methods which allow the debtor to fulfill an obligation after a reminder may be complex and actually deter fulfillment.

Embodiments of the present invention provide solutions to these and other problems.

### BRIEF DESCRIPTION OF THE INVENTION

In one embodiment, a system for receiving a payment for a financial obligation of a payer via a staged transaction, and for identifying an originator of the staged transaction after satisfaction of the staged transaction, is provided. The system may include a collection system, a provider system, and a provider subsystem. The collection system may be configured to, at the direction of the originator, associate the financial obligation with an identifier, where the identifier may be unique to the financial obligation and indicative of the originator. The collection system may also be configured to associate the staged transaction with the identifier. The collection system may further be configured to provide the identifier for communication to the payer. The provider system may be configured to receive a first record related to the staged transaction from the collection system. The provider system may also be configured to receive a second record related to the staged transaction, where the second record indicates a payment has been received for the financial obligation. The provider system may further be configured to send a third record related to the staged transaction to the collection system, where the third record indicates a payment has been received for the financial obligation. The provider subsystem may be configured to receive the identifier from the payer. The provider subsystem may also be configured to send the second record related to the staged transaction to the provider system.

In another embodiment, a method for receiving a payment for a financial obligation owed to a receiver by a payer via a staged transaction is provided. The method may include associating the financial obligation with an identifier, where the identifier is unique to the financial obligation. The method may also include associating the staged transaction with the identifier. The method may further include providing the identifier to the payer. The method may additionally include receiving, from the payer, a payment associated with the identifier. The method may moreover include communicating receipt of the payment associated with the identifier to the receiver.

In another embodiment, a system for staging payment transactions related to financial obligations is provided. The system may include a provider system. The provider system may be configured to receive a staged payment transaction record from a collection system, where the collection system is remote from the provider system. The provider system may also be configured to associate the staged payment transaction record with an identifier which is unique to the staged payment transaction record. The provider system may further be configured to receive a payment notification from a provider subsystem. The provider subsystem may be remote from the provider system and the collection system. The payment notification may be associated with the identifier. The provider system may additionally be configured to transmit a confirmation notification to the collection system, where the confirmation notification is associated with the identifier.

### BRIEF DESCRIPTION OF THE DRAWINGS

The present invention is described in conjunction with the appended figures:

FIG. 1 is a block diagram of a system of the invention for receiving a payment for a financial obligation of a payer via a staged transaction, and for identifying an originator of the staged transaction after satisfaction of the staged transaction;

FIG. 2 is a block diagram of a method of the invention for receiving a payment for a financial obligation of a payer via a staged transaction, and for identifying an originator of the staged transaction after satisfaction of the staged transaction; and

FIG. 3 is a block diagram of an exemplary computer system capable of being used in at least some portion of the apparatuses or systems of the present invention, or implementing at least some portion of the methods of the present invention.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

The ensuing description provides exemplary embodiments only, and is not intended to limit the scope, applicability or configuration of the disclosure. Rather, the ensuing description of the exemplary embodiments will provide those skilled in the art with an enabling description for implementing one or more exemplary embodiments. It being understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other elements in the invention may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed, but could have additional steps not discussed or included in a figure. Furthermore, not all operations in any particularly described process may occur in all embodiments. A process may correspond to a method, a function, a procedure, a subroutine, a subprogram, etc. When a process corresponds to a function, its termination corresponds to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments of the invention may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

In one embodiment of the invention, a system for receiving a payment for a financial obligation of a payer via a staged transaction, and for identifying an originator of the staged transaction after satisfaction of the staged transaction, is provided. The system may include a collection system, a provider system, and a provider subsystem. A staged transaction may, merely by way of example, include any transaction which is set-up or arranged—for prior to actual consummation. As an example, collecting the name of a payee, a payer, an amount, and a payment source may allow a transaction to be staged, so that at the direction of one or both of the parties, the transaction may then more quickly occur once consummation is desired. In another example, a staged transaction could merely include an invoice for goods or services, where the payee and the amount requested are all that are known. Many other types of staged transactions are possible in embodiments of the invention.

The collection system may be configured to, at the direction of the originator, associate the financial obligation with an identifier, where the identifier may be unique to the financial obligation and/or indicative of the originator. The originator may include a person, other than the payer, who is responsible for initiating creation of the staged transaction record. The collection system may also be configured to associate the staged transaction with the identifier.

The identifier may be any type of representative value that assists in identifying the associated financial obligation, staged transaction, and/or originator. Merely by way of example, the identifier may include an alphanumeric value. In some embodiments, the identifier may include both an alphanumeric value and/or another machine readable value such as a barcode that may be used in tandem with, and/or instead of, the alphanumeric value. In some embodiments, any specific financial obligation may have a different and unique identifier. In these or other embodiments, any specific staged transaction may have a different and unique identifier. In some embodiments, an identifier may uniquely identify both a financial obligation and a staged transaction. In some embodiments, any identifier used by the system may be associated with a single originator.

In other embodiments, any identifier used by the system may be associated with a single originator and possibly one or more follow-up agents, such follow-up agents being persons or automated systems which follow up with the payer after initial creation of the staged transaction by the originator. In the above embodiments then, any identifier may be analyzed to determine the originator and/or follow-up agents associated with that identifier, and consequently the financial obligation, staged transaction, and/or the payer associated with that obligation or transaction. In yet other embodiments, the identifier associated with a staged transaction may change when a follow-up agent assists in collecting on an obligation.

In some embodiments, the collection system may be operated by a merchant and/or service provider to whom individuals and/or other merchants and service providers incur financial obligations. In some embodiments, the service provider may be an entity which assists in financial collection efforts of merchants and/or service providers. The collection system may be a computer as described herein, and/or possibly a software application employed on the computer. In various embodiments, the computer system and/or the software application may be associated with and/or owned by the provider associated with the provider system and provider subsystems.

The originator may be a person employed by the merchant and/or service provider. In some embodiments, the originator may be an automated software program with different operating parameters being present in different such automated originators. Merely by way of example, different originator software programs may be programmed to interact with individuals and/or merchants and service providers and interact differently with them via preprogrammed communication substance and methods. In this manner, automated originators may have their performance in recovery of obligations compared relative to each other, as well as human originators.

In some embodiments, the collection system may further be configured to provide the identifier for communication to the payer. The originator may relate the identifier to the payer, and/or the identifier may be automatically related to the payer. In these or other embodiments, the collection system may additionally be configured to communicate the identifier to the payer via a wireless network, possibly via computerized voice, Short Message Service (“SMS”), and/or e-mail. In some embodiments, the collection system may be further configured to repeat communication of the identifier to the payer via the wireless network or other secondary network. Repetition may be necessary if the collection system is responsible for first verbally relating the identifier to the payer, and then also follows up with a soft-copy of the identifier to the payer, possibly via SMS and/or e-mail.

In some embodiments, providing the identifier to the payer may include providing the identifier to the payer via a wireless device, possibly via SMS or e-mail. In these or other embodiments, the payer may use the same or other wireless device to initiate the payment. In these embodiments, the payment may be made via ACH, credit card, and/or online service (for example, PayPal™). In some embodiments, the payer using the wireless device to initiate the payment may include a charge to an account associated with charges for use of the wireless device (for example, via a mobile wallet service).

In some embodiments, the collection system may be remotely located from the provider system. Merely by way of example, a merchant or service provider may operate their own provider system in one geographic location, while the provider system may be operated by a money transfer provider in another geographic location. In these and other embodiments, the provider subsystem may be remotely located from the provider system. In other embodiments, the provider system and provider subsystem may be located in substantially the same geographical location. In some embodiments, the system may include a plurality of provider subsystems, where at least one, if not all, are located geographically remote from the provider system.

The provider system may be configured to receive a first record related to the staged transaction from the collection system. The collection system, possibly at the direction of an originator may create and transmit the first record which broadly and/or specifically represents the staged transaction. In some embodiments, the first record may include details of the staged transaction, for example an amount of the financial obligation, or some portion thereof; a name of the payer; an address of the payer; an account number of the payer; a name of the recipient; an address of the recipient; an account number at a financial institution where payment should be directed by the system; etc. The first record may also include the identifier.

In other embodiments, the first record may include the minimum information necessary for the payer to make a payment, and therefore provide at least relative anonymity vis-à-vis the provider system. For example, the first record may only include the identifier and an amount of the transaction (in addition to information necessary to route the payment back to the recipient). In some embodiments, only the identifier and information necessary to route the payment back to the recipient may be present in the first record, and the amount of the transaction may only be known to the payer, with the provider system merely transferring whatever value is provided by the payer. In these embodiments, complete satisfaction of the obligation is a matter for resolution between the payer and recipient, to the exclusion of concern by the provider system.

In some embodiments, the staged transaction may include a plurality of staged subtransactions, where full payment of the financial obligation causes a flag to be applied to each of the plurality of subtransactions in one or more records. In these embodiments, each subtransaction may either be associated with a separate identifier or a common identifier. In embodiments using separate identifiers, the identifiers may bear some relation to each other, such as common portions and uncommon portions. Merely by way of example, the following alphanumeric identifiers may denote related subtransactions: 69123A, 69123B, 69123C, and 69123D. In yet other embodiments, the financial obligation may be a particular instance of a recurring transaction.

In some embodiments, a transaction may be staged by the receiver ahead of time, with instructions for the provider system, and/or related systems and individuals, to transmit notifications, including possibly at least the identifier, to the sender at a later date. Subsequent delinquency reminders may also be transmitted from the provider system to the sender if payment is not received.

In some embodiments, a receiver of the payment from sender may include an entity in a first country foreign to a second country of the payer. In these or other embodiments, the system may include a database or storage device which include a list of rules, where each rule applied to transfers of money between a first country and a second country. Any of the various systems or subsystems of the embodiments of the invention may be configured to identify from the list of rules a particular rule that applies to transfers of money between the first country and the second country. Any of the various systems or subsystems of the embodiments of the invention may further be configured to verify that the payment comports with the particular rule, and providing the identifier to the payer may include providing the identifier to the payer after verifying, with one or more of the systems or subsystems of the embodiments of the invention, that the payment comports with the particular rule. Merely by way of example, a rule may describe maximum limits on the amount of financial transfers and how often those transfers can occur, by law of both the receiver's country and the sender's country. In embodiments where foreign payments are possible, currency exchange may be effectuated by one or more of the systems or subsystems of the invention.

In these cross-border transactions, foreign currency exchange, escrow, and document filing services may be provided at the provider system or elsewhere. In one example, the provider system could provide currency exchange at the request of the sender or receiver, based on exchange rates either before the transfer is requester, at the time the transfer is requested, or at the time the money is received by the receiver. Additionally, the receiver may also direct which type of currency a payment must be received in at the time of payment, regardless of other exchange rates.

In another example, the provider service could escrow the money until a certain condition is met either by the sender or receiver, or both. Finally, in yet another example, any necessary documents accompanying such a money transfer (either due to sender, receiver, or governmental requirements) could be allowed for by the provider system. These documents could be completed by the sender or receiver and digitally accompany the money transfer.

The provider system may also be configured to receive a second record related to the staged transaction, where the second record indicates a payment has been received for the financial obligation. The third record may include the identifier. The provider subsystem, which may be located at one of a plurality of geographically distinct provider-associated physical office locations, may create and transmit the second record. The provider subsystem may create and transmit the second record after physical receipt of either cash funds or other information necessary to initiate another form of payment (ACH, credit card, etc.) by an agent and/or automated system at the location of the payment by the payer. In some embodiments, the provider subsystem may be an automated system which accepts electronic payment via payer initiated processes such as online payment via ACH, credit card, etc.

The provider system may further be configured to send a third record related to the staged transaction to the collection system, where the third record indicates a payment has been received for the financial obligation. The third record may include the identifier. The third record may work to inform the merchant, service provider, and/or person-receiver of the payment that payment has been made by the payer.

In some embodiments, the collection system may be further configured to receive the third record and create a fourth record correlating the payment with the originator. In some of these embodiments, the collection system may be configured to identify the originator based only on the third record. In these or other embodiments, being configured to identify the originator based only on the third record may implicate identifying the originator based only on the identifier. In all of these embodiments, the identification of the originator may allow the collection system, and/or an entity associated with the collection system (for example, a merchant and/or service provider), to evaluate the effectiveness of a particular originator, possibly relative to other possible originators employed by at the collection system.

Each provider subsystem may be configured to receive the identifier from the payer. In some embodiments, the payer may only provide the identifier and the payment to the provider subsystem. The provider subsystem may, merely by way of example, be a computer, a network terminal, or a point-of-sale device operated by a person at the provider subsystem location. In other embodiments, the provider subsystem may be self serve so that a payer may make the payment without assistance in-person. In these or other embodiments, the payment may be information sufficient to cause an electronic payment to occur, and not actual tendering of currency. The provider subsystem may be operable to accept a payment, either in cash or other means from the payer, or record such payment. In yet other embodiments, the provider subsystem may be remote from the payer and may accept electronic payment information. The provider subsystem may be in communication with financial systems necessary to effectuate the funds transfer of the payment.

The provider subsystem may also be configured to send the second record related to the staged transaction to the provider system. As discussed supra, the second record may indicate a payment has been received from the payer for the financial obligation. The second record may include, as discussed above, and for example, the identifier.

In some embodiments, the provider subsystem may be one of a plurality of provider subsystems. In these or other embodiments, the collection system may be configured to identify the provider system as one of the plurality of provider subsystems which is closest geographically to the payer, possibly via zip code. The collection system, or an originator interfacing with the collection system and the payer, may have access to a database of provider subsystems which can be searched for locations in proximity to a location provided by the payer (possibly the payers present or usual location).

In another embodiment of the invention, a method for receiving a payment for a financial obligation owed to a receiver by a payer via a staged transaction is provided. The method may include associating the financial obligation with an identifier, where the identifier is unique to the financial obligation. The method may also include associating the staged transaction with the identifier. The method may further include providing the identifier to the payer. The method may additionally include receiving, from the payer, a payment associated with the identifier. The method may moreover include communicating receipt of the payment associated with the identifier to the receiver. The method may also include any of the other operations described herein, supra or infra.

In another embodiment of the invention, a system for staging payment transactions related to financial obligations is provided. The system may include a provider system. The provider system may be configured to receive a staged payment transaction record from a collection system, where the collection system is remote from the provider system. The provider system may also be configured to associate the staged payment transaction record with an identifier which is unique to the staged payment transaction record. The provider system may further be configured to receive a payment notification from a provider subsystem. The provider subsystem may be remote from the provider system and the collection system. The payment notification may be associated with the identifier. The provider system may additionally be configured to transmit a confirmation notification to the collection system, where the confirmation notification is associated with the identifier. The system may also include any of the other components described herein, supra or infra, to perform any of the other operations described herein, supra or infra.

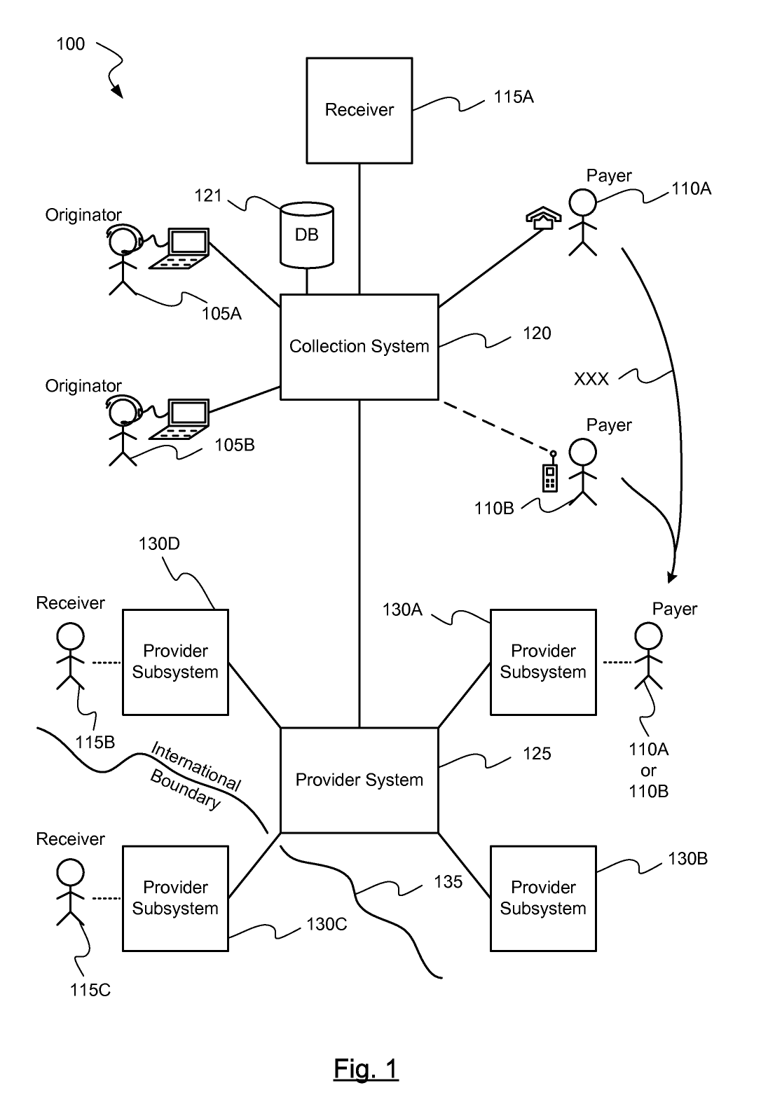

Turning now to FIG. 1, a block diagram of a system 100 of the invention for receiving a payment for a financial obligation of a payer via a staged transaction, and for identifying an originator 105 of the staged transaction after satisfaction of the staged transaction, is shown.

Initially a financial obligation is incurred by payer 110 in favor of receiver 115. The financial obligation may be the result of a purchase of goods or services of receiver 115, or merely a desire to transfer money by payer 110 to receiver 115. Payer 110 may be a person or business in various embodiments.

If a payment is not otherwise received by receiver 115 for the financial obligation, collection system 120 may receive a record representing the financial obligation. This record may, merely by way of example, include the payer's name, the receiver's name, contact information for the payer, an amount of the obligation, the terms of the obligation (number and amounts of payments necessary on specific dates), discount information (reduction of obligation if payment is made by certain dates), etc.

Collection system 120, possibly at the direction of originator 105, may associate the obligation record with an identifier. This record may then be stored in storage device 121.

Originator 105, and/or an automated subsystem of collection system 120, may then contact payer 110 and confirm their desire to fulfill the financial obligation. If payer 110 desires to fulfill the obligation, the identifier may be communicated to payer 110 by originator 105 and/or collection system 120. In some embodiments, the identifier may not be created and associated with the obligation until confirmation of a desire by payer 110 to make payment is received.

Originator 105, and/or an automated subsystem of collection system 120 or provider system 125, may then create a staged transaction and associate the staged transaction with the identifier. The identifier may then be communicated to payer 110. These communications with payer may occur via a traditional or Voice-over-Internet-Protocol (“VoiP”) phone (for example, as payer 110A is shown in FIG. 1), or via a mobile phone (for example, as payer 110B is shown in FIG. 1). Further reminders of the identifier and/or obligation to payer 110 may be done over any of these means, or other means, including for example, traditional mail and/or e-mail.

Originator 105, and/or an automated subsystem of collection system 120 or provider system 125, may communicate to payer the location of provider subsystem 130 closest to payer 110, possibly based on current or anticipated geographic location of payer 110. Current or anticipated location of payer 110 may be supplied either by payer 110 themselves, or possibly via a Global Positioning System device (“GPS”) or other location identifying device associated with payer 110 and/or a mobile communication device of payer 110.

Payer 110 may thereafter visit the location of a provider subsystem 130 (or make a payment remotely as discussed supra). Payer may provide, possibly at a minimum, the identifier and the payment to provider subsystem 130 (or an agent operating provider subsystem 130).

A record may then be created by provider system 125 or provider subsystem 130 indicating payment has been received for the obligation and/or staged transaction associated with the identifier provided by payer 110. This record, or at least some portion thereof, may be communicated to collection system 130. A further record indicating payment has been received may then be communicated to receiver 115. Note, as shown in FIG. 1, that receiver 115 may be a person (for example, as shown by receiver 115B and 115C), or an entity (for example, as shown by receiver 115A).

In instances where receiver 115 is foreign to payer 110 (for example, as shown by receiver 115C being across international boundary 135), collection system 120, provider system 125, and/or provider subsystem 130 may check any potential staged transaction for compliance with rules/laws regarding such international fund transfers. Domestic fund transfers may also be checked for compliance with domestic fund transfer rules/laws by the same systems.

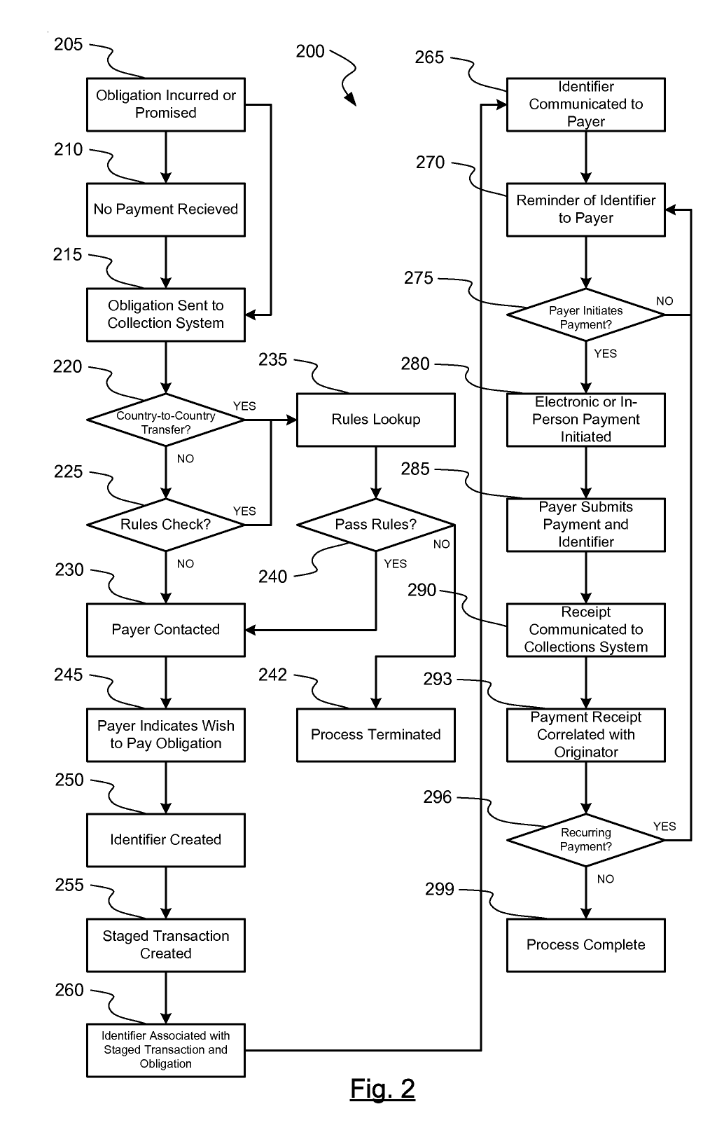

FIG. 2 shows a block diagram of a method 200 of the invention for receiving a payment for a financial obligation of a payer via a staged transaction, and for identifying an originator of the staged transaction after satisfaction of the staged transaction. Any of the steps described herein may occur at any of the systems or subsystems of the invention.

At block 205, a financial obligation is incurred by payer 110 in favor or receiver 115. At block 210, a payment on the financial obligation has not been received by receiver 115. At block 215, the obligation is sent to collection system 120 for processing according to a method of the invention. In some embodiments, a financial obligation may be immediately sent to collection system 120, regardless of whether an intervening time period of non-payment 210 has occurred.

At block 220, it is determined whether or not payment of the obligation would involve a country-to-country transfer. If not, at block 225, it is determined whether other rules may apply to the payment. If not, then the payer is contacted at block 230.

If at block 220 it is determined that the payment involves a country-to-country transfer, then rules applicable to the specific transfer are accessed at block 235. At block 240, it is determined whether or not the applicable rules are adhered to by the transfer. If the rules are not adhered to by the potential transfer, then the process is terminated at block 242. Process termination may include communicating to payer 110 and/or receiver 115 the particular rules which would be violated by the transfer. If the rules are adhered to by the potential transfer, then the process continues at block 230.

If at block 225, if it is determined that the payment implicates the applicability of other financial transfer rules, then rules applicable to the specific transaction are accessed at block 235. At block 240, it is determined whether or not the applicable rules are adhered to by the transfer. If rules are not adhered to by the potential transfer, then the process is terminated at block 242. Process termination may include communicating to payer 110 and/or receiver 115 the particular rules which would be violated by the transfer.

At block 245, payer 110 indicates a wish to pay the obligation. At block 250, an identifier is created, possibly at collection system 120. At block 255, a staged transaction is created, possibly by collection system 120 and/or the provider system 125. At block 260, the identifier is associated with the staged transaction.

At block 265, the identifier is communicated to payer 110. At block 270, if so desired, payer 110 can be reminded of the staged transaction and the identifier can again be communicated if a payment is not initiated at block 275. If a payment is initiated at block 275, payer 110 may initiate an electronic or in-person payment at block 280. At block 285, payer 110 submits identifier and payment to provider subsystem 130 to complete the payment process on their end.

At block 290, receipt of the payment is reported to collection system 120. The collection system may thereafter report the receipt of payment to receiver 115. At block 293, collection system 120 may correlate that a particular originator 105 is associated with the successful collection on the financial obligation by analyzing the identifier, which though unique to the transaction, may be indicative of the particular originator 105. Reports on successful rates of payer-interaction and collections can then be produced for any one of, or plurality of, a number of originators.

At block 296, it is checked as to whether or not the transaction is a recurring transaction. If so, portions of method 200 may be repeated as necessary to effectuate additional payments. If not, the process may be complete at block 299.

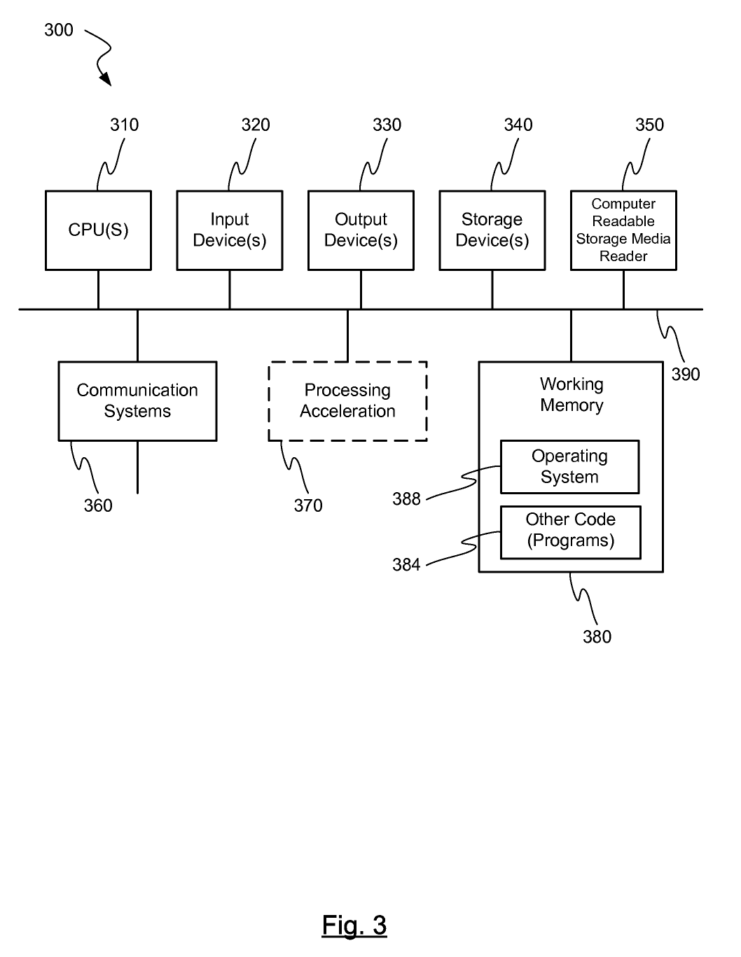

FIG. 3 is a block diagram illustrating an exemplary computer system 300 in which embodiments of the present invention may be implemented. This example illustrates a computer system 300 such as may be used, in whole, in part, or with various modifications, to provide the functions of the receiver, the collection system, the provider system, the provider subsystem and/or other components of the invention such as those discussed above. For example, various functions of the collection system may be controlled by the computer system 300, including, merely by way of example, associating the financial obligation with an identifier, associating the staged transaction with the identifier, and providing the identifier for communication to the payer, etc.

The computer system 300 is shown comprising hardware elements that may be electrically coupled via a bus 390. The hardware elements may include one or more central processing units 310, one or more input devices 320 (e.g., a mouse, a keyboard, etc.), and one or more output devices 330 (e.g., a display device, a printer, etc.). The computer system 300 may also include one or more storage device 340. By way of example, storage device(s) 340 may be disk drives, optical storage devices, solid-state storage device such as a random access memory (“RAM”) and/or a read-only memory (“ROM”), which can be programmable, flash-updateable and/or the like.

The computer system 300 may additionally include a computer-readable storage media reader 350, a communications system 360 (e.g., a modem, a network card (wireless or wired), an infra-red communication device, Bluetooth™ device, cellular communication device, etc.), and working memory 380, which may include RAM and ROM devices as described above. In some embodiments, the computer system 300 may also include a processing acceleration unit 370, which can include a digital signal processor, a special-purpose processor and/or the like.

The computer-readable storage media reader 350 can further be connected to a computer-readable storage medium, together (and, optionally, in combination with storage device(s) 340) comprehensively representing remote, local, fixed, and/or removable storage devices plus storage media for temporarily and/or more permanently containing computer-readable information. The communications system 360 may permit data to be exchanged with a network, system, computer and/or other component described above.

The computer system 300 may also comprise software elements, shown as being currently located within a working memory 380, including an operating system 384 and/or other code 388. It should be appreciated that alternate embodiments of a computer system 300 may have numerous variations from that described above. For example, customized hardware might also be used and/or particular elements might be implemented in hardware, software (including portable software, such as applets), or both. Furthermore, connection to other computing devices such as network input/output and data acquisition devices may also occur.

Software of computer system 300 may include code 388 for implementing any or all of the function of the various elements of the architecture as described herein. For example, software, stored on and/or executed by a computer system such as system 300, can provide the functions of the receiver, the collection system, the provider system, the provider subsystem, and/or other components of the invention such as those discussed above. Methods implementable by software on some of these components have been discussed above in more detail.

The invention has now been described in detail for the purposes of clarity and understanding. However, it will be appreciated that certain changes and modifications may be practiced within the scope of the appended claims.

What is claimed is:

1. A system for receiving a payment for a financial obligation of a payer via a staged transaction, and for identifying an originator of the staged transaction after satisfaction of the staged transaction, wherein the system comprises:
a collection system, wherein, at the direction of the originator, the collection system is configured to:
associate the financial obligation with an identifier, wherein the identifier is unique to the financial obligation and indicative of the originator;
associate the staged transaction with the identifier; and
provide the identifier for communication to the payer;
a provider system, wherein the provider system is configured to:
receive a first record related to the staged transaction from the collection system;
receive a second record related to the staged transaction, wherein the second record indicates a payment has been received for the financial obligation; and
send a third record related to the staged transaction to the collection system, wherein the third record indicates a payment has been received for the financial obligation; and
a provider subsystem, wherein the provider subsystem is configured to:
receive the identifier from the payer; and
send the second record related to the staged transaction to the provider system.

2. The system for receiving a payment for a financial obligation of a payer via a staged transaction, and for identifying an originator of the staged transaction after satisfaction of the staged transaction, of claim 1, wherein:
the collection system is remotely located from the provider system; and
the provider subsystem is remotely located from the provider system.

3. The system for receiving a payment for a financial obligation of a payer via a staged transaction, and for identifying an originator of the staged transaction after satisfaction of the staged transaction, of claim 1, wherein the collection system is further configured to communicate the identifier to the payer via a wireless network.

4. The system for receiving a payment for a financial obligation of a payer via a staged transaction, and for identifying an originator of the staged transaction after satisfaction of the staged transaction, of claim 3, wherein the collection system is further configured to repeat communication of the identifier to the payer via the wireless network or a secondary network.

5. The system for receiving a payment for a financial obligation of a payer via a staged transaction, and for identifying an originator of the staged transaction after satisfaction of the staged transaction, of claim 1, wherein:
the third record includes the identifier;
the collection system is further configured to:
receive the third record; and
create a fourth record correlating the payment with the originator.

6. The system for receiving a payment for a financial obligation of a payer via a staged transaction, and for identifying an originator of the staged transaction after satisfaction of the staged transaction, of claim 1, wherein the collection system is further configured to identify the originator based only on the third record.

7. The system for receiving a payment for a financial obligation of a payer via a staged transaction, and for identifying an originator of the staged transaction after satisfaction of the staged transaction, of claim 6, wherein the third record comprises the identifier, and the collection system being further configured to identify the originator based only on the third record comprises the collection system being configured to identify the originator based only on the identifier.

8. The system for receiving a payment for a financial obligation of a payer via a staged transaction, and for identifying an originator of the staged transaction after satisfaction of the staged transaction, of claim 1, wherein the payer only provides the identifier and the payment to the provider subsystem.

9. The system for receiving a payment for a financial obligation of a payer via a staged transaction, and for identifying an originator of the staged transaction after satisfaction of the staged transaction, of claim 8, wherein the payment comprises information sufficient to cause an electronic payment to occur.

10. The system for receiving a payment for a financial obligation of a payer via a staged transaction, and for identifying an originator of the staged transaction after satisfaction of the staged transaction, of claim 1, wherein the staged transaction comprises a plurality of staged subtransactions, and wherein full payment of the financial obligation causes a flag to be applied to each of the plurality of subtransactions.

11. A method for receiving a payment for a financial obligation owed to a receiver by a payer via a staged transaction, wherein the method comprises:
associating the financial obligation with an identifier, wherein the identifier is unique to the financial obligation;
associating the staged transaction with the identifier;
providing the identifier to the payer;
receiving, from the payer, a payment associated with the identifier; and
communicating receipt of the payment associated with the identifier to the receiver.

12. The method for receiving a payment for a financial obligation owed to a receiver by a payer via a staged transaction of claim 11, wherein the identifier is indicative of an originator of the staged transaction.

13. The method for receiving a payment for a financial obligation owed to a receiver by a payer via a staged transaction of claim 11, wherein the financial obligation comprises a particular instance of a recurring transaction.

14. The method for receiving a payment for a financial obligation owed to a receiver by a payer via a staged transaction of claim 11, wherein the receiver comprises an entity in a first country foreign to a second country of the payer, and wherein the method further comprises:
identifying from a list of rules a particular rule that applies to transfers of money between the first country and the second country; and
verifying that the payment comports with the particular rule.

15. The method for receiving a payment for a financial obligation owed to a receiver by a payer via a staged transaction of claim 14, wherein providing the identifier to the payer comprises providing the identifier to the payer after verifying that the payment comports with the particular rule.

16. The method for receiving a payment for a financial obligation owed to a receiver by a payer via a staged transaction of claim 11, wherein providing the identifier to the payer comprises providing the identifier to the payer via a wireless device, and wherein the method further comprises the payer using the wireless device to initiate the payment.

17. The method for receiving a payment for a financial obligation owed to a receiver by a payer via a staged transaction of claim 16, wherein the payer using the wireless device to initiate the payment comprises a charge to an account associated with charges for use of the wireless device.

18. A system for staging payment transactions related to financial obligations, wherein the system comprises:
a provider system configured to:
receive a staged payment transaction record from a collection system, wherein the collection system is remote from the provider system;
associate the staged payment transaction record with an identifier which is unique to the staged payment transaction record;
receive a payment notification from a provider subsystem, wherein:
the provider subsystem is remote from the provider system and the collection system; and
the payment notification is associated with the identifier; and
transmit a confirmation notification to the collection system, wherein the confirmation notification is associated with the identifier.

19. The system for staging payment transactions related to financial obligations of claim 18, wherein the identifier is indicative of an originator of the staged payment transaction record, and wherein the originator comprises a person, other than the payer, responsible for initiating creation of the staged transaction record.

20. The system for staging payment transactions related to financial obligations of claim 18, wherein the provider subsystem is one of a plurality of provider subsystems, and the collection system is configured to identify the provider system as one of the plurality of provider systems which is closest geographically to the payer.
